(19) United States
(12) Patent Application Publication
(10) Pub. No.: US 2024/0061903 A1
(43) Pub. Date: Feb. 22, 2024

(54) SOFTMAX AND LOG SOFTMAX METHOD AND SYSTEM

(71) Applicant: Xilinx, Inc., San Jose, CA (US)

(72) Inventors: Wenzong Yang, Beijing (CN); Wang Xi, Beijing (CN); Yadong Li, Beijing (CN); Junbin Wang, Beijing (CN); Shaoxia Fang, Beijing (CN)

(73) Assignee: Xilinx, Inc., San Jose, CA (US)

(21) Appl. No.: 17/892,852

(22) Filed: Aug. 22, 2022

(51) Int. Cl. G06F 17/16; G06F 7/544; G06F 7/552; G06F 7/499

(52) U.S. Cl. CPC G06F 17/16; G06F 7/5443; G06F 7/552; G06F 7/4991

(57) ABSTRACT

Circuits and methods for determining a maximum bias for computing softmax on a tensor include a processor circuit configured to transform in parallel, elements of each group of a plurality of groups of elements of a tensor X into respective power-of-two elements. The respective power-of-two element from element xₜ of the tensor is pₜ, pₜ=(xₜ*log₂e), and pₜ has an integer part and a fraction part. A first comparison circuit (204) is configured to determine respective group-level biases for the groups. The group-level bias of groupₘ is dₘ, and dₘ is an integer part of a maximum of the power-of-two elements of groupₘ. A second comparison circuit is configured to determine a greatest one of the respective group-level biases to be a tensor-level bias, dₘₐₓ.

### TECHNICAL FIELD

The disclosure generally relates to circuits for accelerating softmax and log softmax computations.

### BACKGROUND

The softmax function applied to a vector X of n+1 real values (indexed 0 . . . n), normalizes the values into a probability distribution consisting of n+1 probabilities proportional to the exponentials of the input values. Some vector elements may be negative or greater than one. Each element in the tensor resulting from application of the softmax function will be in the interval (0, 1), and the elements sum to 1. The softmax function on element xₜ (subscripts alternatively denoted “x_t” herein) of an input tensor can be stated as:

softmax(xₜ)=e^{x_t}/SUM(y=0 . . . N,(e^{x_y}))

In order to avoid overflow, the element having the greatest value (xₘₐₓ) in the input tensor is subtracted from the exponents in the calculation.

softmax(xₜ)=(e^{x_t-x_max})/SUM(y=0 . . . N(e^{x_y-x_max)}))

In applications involving large tensors, traversing all elements of the tensor to find the maximum value can consume a considerable amount of time, and until the maximum of the tensor elements is found, the exponential function calculation will be blocked.

For many neural networks, such as convolutional neural networks, recurrent neural networks, etc., softmax is applied only in the final layer. Transformer neural networks are now providing encouraging results in applications previously dominated by CNNs. Notably, each attention layer of a transformer neural network can have softmax and dropout operations in addition to the standard matrix multiplication-based in fully-connected layers. Transformer networks are large and can have hundreds of millions to hundreds of billions of parameters, and the softmax function can have a significant negative impact on performance.

### SUMMARY

A disclosed method includes transforming in parallel, elements of each group of a plurality of groups of elements of a tensor X into respective power-of-two elements by a processor circuit (202). The respective power-of-two element from element xₜ of the tensor is pₜ, pₜ=(xₜ*log₂e), and pₜ has an integer part and a fraction part. The method includes determining respective group-level biases for the groups by a comparison circuit (204), wherein the group-level bias of groupₘ is dₘ, and dₘ is an integer part of a maximum of the power-of-two elements of groupₘ. The method further includes determining a greatest one of the respective group-level biases by the comparison circuit (206) to be a tensor-level bias, dₘₐₓ.

A disclosed circuit arrangement includes a processor circuit configured to transform in parallel, elements of each group of a plurality of groups of elements of a tensor X into respective power-of-two elements. The respective power-of-two element from element xₜ of the tensor is pₜ, pₜ=(xₜ*log₂e), and pₜ has an integer part and a fraction part. A first comparison circuit is configured to determine respective group-level biases for the groups. The group-level bias of groupₘ is dₘ, and dₘ is an integer part of a maximum of the power-of-two elements of groupₘ. A second comparison circuit is configured to determine a greatest one of the respective group-level biases to be a tensor-level bias, dₘₐₓ.

Other features will be recognized from consideration of the Detailed Description and Claims, which follow.

### BRIEF DESCRIPTION OF THE DRAWINGS

Various aspects and features of the methods and circuits will become apparent upon review of the following detailed description and upon reference to the drawings in which:

FIG. 1 shows a dataflow diagram of data generated in performing operations according to the disclosed approaches for computing a softmax function on a tensor X;

FIG. 2 shows an exemplary circuit arrangement for computing softmax and log(softmax) functions on a tensor X;

FIG. 3 shows a timing diagram of operations performed in computing the softmax function by the circuit arrangement of FIG. 2;

FIG. 4 shows a timing diagram of operations performed by the circuit arrangement of FIG. 2 in computing the log(softmax) function;

FIG. 5 shows a timing diagram of operations of the softmax function performed in parallel with operations of the log(softmax) function by the circuit arrangement of FIG. 2; and

FIG. 6 is a block diagram depicting a System-on-Chip (SoC) that can host circuitry that implements the softmax and log(softmax) functions according to the methods and circuits disclosed herein.

### DETAILED DESCRIPTION

In the following description, numerous specific details are set forth to describe specific examples presented herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element.

The disclosed approaches provide methods and circuitry that addresses the aforementioned issues. This methods and circuits are useful in neural network inference and training. According to the disclosed approaches, the exponential functions of softmax are transformed into 2^{x} form. The transformation is explained as follows.

a^{b}=e^{lna}^{^{b}}=e^{blna}

For a=2 and b*ln(a)=x,

$${e}^{x} = {2}^{\frac{x}{ln 2}} = {2}^{x * {log}_{2} e}$$

$${e}^{x - {x}_{max}} = {2}^{\frac{x - {x}_{max}}{ln 2}} = {2}^{x * {log}_{2} e} * {2}^{- {x}_{max} * {log}_{2} e}$$

A bias, dₘₐₓ, is computed to prevent overflow and underflow and to align terms for summing as:

dₘₐₓ=[xₘₐₓ*log₂e]

where [⋅] is a floor operation. The softmax function can be restated as:

$$soft max ( x\_t ) = \frac{{e}^{{x}_{t} - bias}}{\sum {e}^{{x}_{t} - bias}} = \frac{{2}^{- {d}_{max}} {e}^{{x}_{t}}}{{2}^{- {d}_{max}} \sum {e}^{{x}_{t}}} = \frac{{2}^{- {d}_{max}} {2}^{{x}_{t} * {log}_{2} e}}{{2}^{- {d}_{max}} \sum {2}^{{x}_{t} * {log}_{2} e}}$$

where xₜ is element t of tensor X, and the summations are of all xₜ in X.

The term, 2^{x}^{ₜ}^{*log}^{₂}^{e} can be written as:

2^{x}^{ₜ}^{*log}^{₂}^{e}=2^{x}^{_{t_k}}*2^{x}^{_{t_j}}

where x_{t_k} is the integer part, x_{t_j} is the fractional part of (xₜ*log₂e), and x_{t_j} is in the interval [0, 1). To calculate the softmax function according to the disclosed approaches, three components are calculated: x_{t_k}, 2^{(x_t)_j}, and dₘₐₓ. The term, x_{t_j}, is in the interval [0, 1), and 2^{(x_t)_j} can be approximated by polynomial fitting with acceptable precision and degree. The value, 2^{(x_t)_j}, is a floating-point number and can have an 8-bit exponent, for example. After polynomial fitting, the exponent is modified by x_{t_k}−dₘₐₓ.

The disclosed methods and circuitry significantly reduce the time expended in computing dₘₐₓ by dividing an input tensor is divided into several groups, converting tensor elements into power-of-two values, determining group-level biases, adjusting the power-of-two values according to the group-level biases, and summing the adjusted values of the groups. The number of tensor elements in each group is set according to the desired level of computational parallelism. In the exemplary methods and circuitry, each group has 8 tensor elements, though different implementations can have more or fewer tensor elements depending on hardware capabilities.

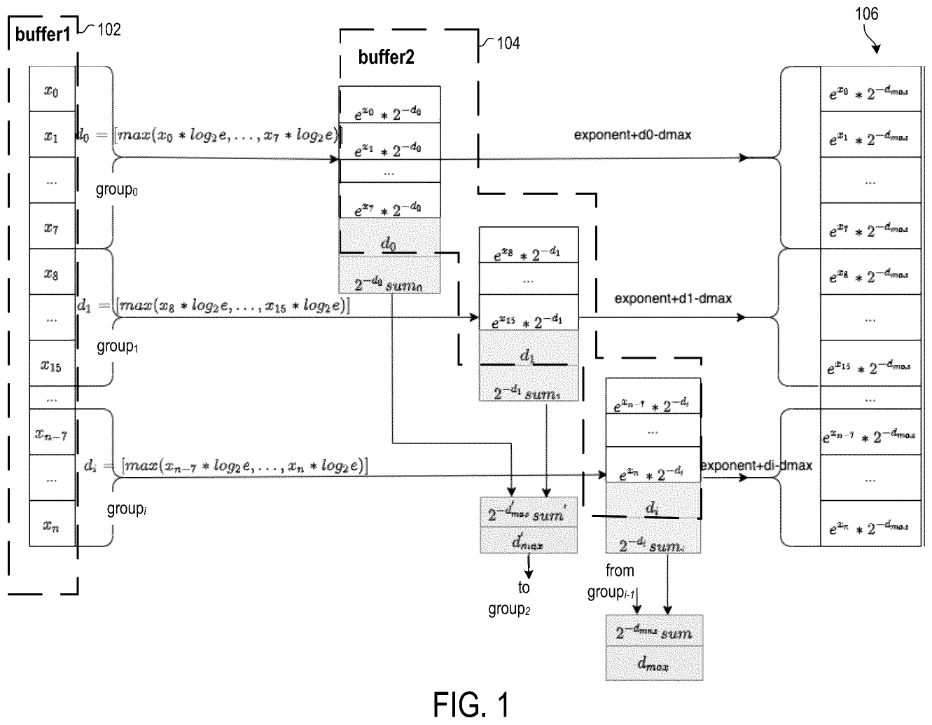

FIG. 1 shows a dataflow diagram of data generated in performing operations according to the disclosed approaches for computing a softmax function on a tensor X. The input tensor has n+1 elements (x₀ . . . xₙ) and i+1 groups of elements (group₀ . . . groupᵢ). Each group has p+1 elements (e.g., p=7). The input tensor is provided in buffer1 as shown by dashed block 102. Buffer1 can be an on-chip or off-chip RAM (relative to computational circuitry), and the tensor elements can be input by a streaming or direct memory access (DMA) interface.

The groups of elements can be input one group at a time, and a processor circuit is configured to multiply the elements of the group by log₂e in parallel (xₜ*log₂e for t=0 . . . 7). The purpose multiplying xₜ*log₂e is to transform e^{x_t} to the form 2^{y} (“power-of-two form”), where y=xₜ*log₂e, per the derivations above. The products produced from each group m are used to determine the group-level bias, dₘ. The dₘ of group m is the integer part of the greatest one of the products of the group ([max (xₜ*log₂e for t=0 . . . 7))]). A tensor-level bias, dₘₐₓ, is determined by finding the greatest of the dₘ values as the groups are successively processed.

The dₘ along with the x_{t_k} and 2^{(x_t)_j}, values are used to adjust the computed products and prevent overflow and underflow relative to the group. The 2^{(x_t)_j}, values for a group are determined by polynomial fitting, and the power-of-two values are adjusted by x_{t_k}−dₘ+(the exponent bits of 2^{(x_t)_j}). The group-biased power-of-two values, e^{x_t}*2^{-d_m}, are stored in association with the group-level dₘ as each group is computed in buffer2, which is shown by dashed block 104. Each e^{x_t}*2^{-d_m} is a floating point value having an exponent equal to x_{t_k}−dₘ+(the exponent bits of 2^{(x_t)_j}), and a mantissa equal to the mantissa of 2^{(x_t)_j}. Buffer2 can be an on-chip or off-chip RAM (relative to computational circuitry), and the group-level dₘ values and associated group-biased power-of-two values can be input by a streaming or direct memory access (DMA) interface.

The adjusted power-of-two values are accumulated into a group-level sum (2^{-d_m} sumₘ=SUM_{group_m}=sum(e^{x_t}*2^{-d_m}) for all t in groupₘ) as the adjusted power-of-two values are computed. The group-level sums are accumulated into a tensor-level sum as each group is accumulated. The group-level dₘ is compared to the group level d′ₘₐₓ once dₘ is determined, and the group-level sum 2^{-d_m} sumₘ is aligned with the current sum (2^{-d′_max} sum′) according to the current value of d′ₘₐₓ. Once aligned, the aligned group-level sum 2^{-d_m} sumₘ is added to the current sum (2^{-d′_max} sum′) to produce a new current sum.

The tensor-level dₘₐₓ and tensor level sum, 2^{-d_max} sum, (which is 2^{-d}^{ₘₐₓ}Σe^{x}^{ₜ}) are available for the next stage of softmax computation once the tensor elements of groupᵢ have been processed.

Once dₘₐₓ has been determined, the group-biased power-of-two values (e^{x_t}*2^{-d_m}) are tensor-wise adjusted based on the tensor-level dₘₐₓ value. The tensor-wise biases for elements in groupₘ are made by retrieving from buffer2, dₘ and exponents of the associated group-wise-adjusted power-of-two values e^{x_t}*2^{-d_m}. The exponents of e^{x_t}*2^{-d_m} in groupₘ are added to (dₘ−dₘₐₓ) to generate the exponents of the e^{x_t}* 2^{-d_max} values, which are illustrated in the column 106 of blocks. The mantissas of the e^{x_t}*2^{-d_max} values are the same as the mantissas of the corresponding values from buffer2. Though not shown in FIG. 1, it will be recognized that each of the e^{x_t}*2^{-d_max} values in column 106 is divided by the tensor level sum, 2^{-d_max} sum to generate softwmax (xₜ).

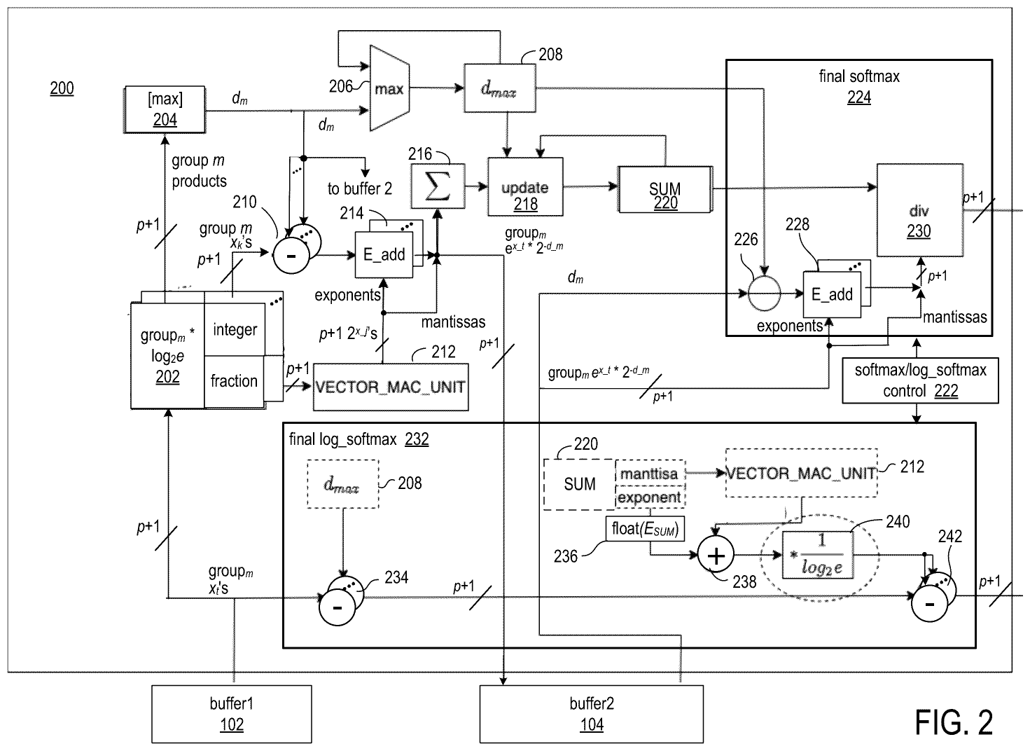

FIG. 2 shows an exemplary circuit arrangement 200 for computing softmax and log(softmax) functions on a tensor X. The circuit arrangement generally includes one or more processor circuits configured to perform parallel multiply-and-accumulate operations, registers for storing temporary result values, and various addition and subtraction circuits.

A group of p+1 tensor elements (xₜ, t=0 . . . p) is read from buffer1 102 and input in parallel to processor circuitry 202. Processor circuit 202 computes products (“power-of-two elements”) of xₜ*log2e for t=0 . . . p in parallel. The p+1 power-of-two elements are provided on parallel signal lines to circuit 204, which compares values of the p+1 power-of-two elements and extracts and provides the integer portion of the greatest one of the values as dₘ. The compare-and-select circuit 206 compares the dₘ value from circuit 204 to the current dₘₐₓ value in register 208 and selects the greater of the two values to update the contents of the register.

The power-of-two elements computed by processor circuits 202 are floating point values, and the integer portions (groupₘ x_{t_k}) and fraction portions (groupₘ x_{t_j}) of the values are determined from the mantissas and exponents. The integer portions are provided to the subtraction circuits 210, and the fraction portions are provided to the processor circuitry 212, which can be a vector processor that performs multiply-and-accumulate (“MAC”) operations in parallel.

The subtraction circuits 210 compute in parallel the differences between the integer portions and the group-level bias, dₘ (x_{t_k}−dₘ for t=0 . . . p). The processor circuitry 212 computes in parallel 2^{(x_t)_j} for t=0 . . . p by polynomial fitting of the fraction portions, x_{t_j}. The tensor elements of the next group (groupₘ₊₁) can be input to the processor circuitry 202 for computing the power-of-two elements while circuit 204 determines the group-level bias dₘ, the subtraction circuits 210 compute the differences (x_{t_k}−dₘ for t=0 . . . p), and the processor circuitry 212 computes 2^{(x_t)_j} for t=0 . . . p for groupₘ.

The differences and exponents of the 2^{(x_t)_j} values are input to adder circuits 214 that compute in parallel the exponents of the group-biased power-of-two elements. Each e^{x_t}*2^{-d_m} is a floating point value having an exponent equal to x_{t_k}−dₘ+(the exponent bits of 2^{(x_t)_j}), and a mantissa equal to the mantissa of 2^{(x_t)_j}. The group-biased power-of-two values for the group are stored in buffer2 104 in association with the group-level bias dₘ.

The group-biased power-of-two values for the group are input to summing circuit 216, which sums the group-biased power-of-two values into a group-level sum (SUMₘ=sum(e^{x_t}*2^{-d_m}) for all xₜ in group m).

The update circuit 218 accumulates the group-level sums as each group-level sum is provided by summing circuit 216. The update circuit 218 inputs the group-level sum from summing circuit 216, the current greatest bias value, dₘₐₓ from register 208, and the current accumulated SUM from register 220. The update circuit aligns the group-level sum and the current accumulated SUM according to dₘₐₓ and produces a new SUM that is stored in register 220.

Once all groups of tensor elements of a tensor (e.g., group₀ . . . groupᵢ of a tensor having i+1 groups) have been processed and a final tensor-level sum has been computed, control circuit 222 can activate the final softmax circuitry 224. The final softmax circuitry generates final softmax values group-by-group, with the p+1 softmax values generated in parallel. The final softmax circuitry inputs the tensor-level bias, dₘₐₓ, from register 208, the final tensor level SUM from register 220 (SUM=2^{-d_max}*sum(2^{x_t*log_2(e)})), and reads the group-biased power-of-two elements of groupₘ and the associated group-level bias dₘ from buffer2 104.

The subtractor circuit 226 of the final softmax circuitry determines the difference between the group-level bias, dₘ, and the tensor-level bias dₘₐₓ (dₘ−dₘₐₓ). The difference from subtractor circuit 226 and the exponents of the group-biased power-of-two elements (exp(e^{x_t}*2^{-d_m})) are input to adder circuits 228. The adder circuits 228 compute in parallel sums of the difference and the exponents of the e^{x_t}*2^{-d_m} terms from buffer 2. The sums from exponent adders 228 are exponents that are paired with the corresponding mantissas of the e^{x_t}*2^{-d_m} terms from buffer2 to provide the tensor-baised terms, “x_{t_dmax}” as divisors to the divider circuit 230. The exponent of x_{t_dmax}. is exp(x_{t_dmax})=(dₘ−dₘₐₓ)+exp(e^{x_t}*2^{-d_m}), and the mantissa of x_{t_dmax}. is man(x_{t_dmax})=man(e^{x_t}*2^{-d_m}).

Divider circuitry 230, which can be a vector division circuit, computes in parallel the final softmax values (x_{t_dmax}/SUM for t=0 . . . p)).

The control circuit 222 controls activation of the final softmax circuit 224 and final log_softmax circuit 232. The final softmax circuit and the final log_softmax circuit can be operated alone or in parallel with one another. For example, in response to a state of mode control signals, the control circuit 222 can activate the final softmax circuit 224 and deactivate final log_softmax circuit 232, deactivate the final softmax circuit 224 and activate final log_softmax circuit 232, or activate both the final softmax circuit 224 and the final log_softmax circuit 232 to operate in parallel. The control circuit 222 can gate clock signals to the final softmax circuit 224 and final log_softmax circuit 232 to reduce power consumption when only one of the circuits is activated.

The formula of log(softmax):

$$log ( soft max ( x ) ) = log ( \frac{{e}^{{x}_{i} - {x}_{max}}}{\sum {e}^{{x}_{i} - {x}_{max}}} ) = ( {x}_{i} - {x}_{max} ) - log ( \sum {e}^{{x}_{i} - {x}_{max}} )$$

The term, 2^{-dmax} Σ2^{x}^{ᵢ}^{log}^{₂}^{e} is used to replace Σe^{x}^{ᵢ}^{-x}^{ₘₐₓ}, and dₘₐₓ is used to replace xₘₐₓ as explained above. Thus, the log(softmax) can be restated as:

log(softmax(x))=(xᵢ−dₘₐₓ)−log(2^{-d}^{ₘₐₓ}Σ2^{xi*log}^{₂}^{e})

The input variable of the natural log function is a floating point number, which is represented in the form:

(−1)^{s}*(1+M)*2^{E-E}^{ₐ}

where s is the sign bit, M is the mantissa, E is the exponent, which is shifted by a constant bias E₀. The log function can be written as:

$$log ( y ) = \frac{{log}_{2} y}{{log}_{2} e} = \frac{1}{{log}_{2} e} ( {log}_{2} ( ( 1 + \text{?} ) * \text{?} ) ) = \frac{1}{{log}_{2} e} ( ( {E}_{y} - {E}_{0} ) + {log}_{2} ( 1 + \text{?} ) )$$

$$\text{?} \text{indicates text missing or illegible when filed}$$

where M_{y} is in the interval to [0, 1), log₂(1+M_{y}) could be calculated by polynomial fitting.

The final log_softmax circuit 232 is activated once the tensor-level dₘₐₓ is available. A group of p+1 tensor elements (xₜ, t=0 . . . p) is read from buffer1 102 and input in parallel to the subtraction circuits 234. The subtraction circuits compute in parallel, differences between (xₜ−dₘₐₓ for t=0 . . . p).

The mantissa (M_{SUM}) of the SUM is input to the processor circuitry 212, which is configured to compute log₂(1+M_{SUM}). The exponent of the SUM (E_{SUM}) is input to circuit 236, which converts E_{SUM} to a floating point value. Adder 238 sums the values output from circuits 212 and 236 (float(E_{SUM})+log₂(1+M_{SUM})), and the sum is input to processor circuitry 240. Processor circuitry 240 is configured to compute:

SUM_{log}=(float(E_{SUM})+log₂(1+M_{SUM}))/log₂e

The processor circuitry 240 can be processor circuitry dedicated to computing SUM_{log}, or circuitry 212.

The SUM_{log} and p+1 differences (xₜ−dₘₐₓ for t=0 . . . p) from subtraction circuits 234 are input to subtraction circuits 242. Subtraction circuits compute in parallel (xₜ−dₘₐₓ)−SUM_{log} for t=0 . . . p, and the p+1 output terms are log (softmax (xₜ)).

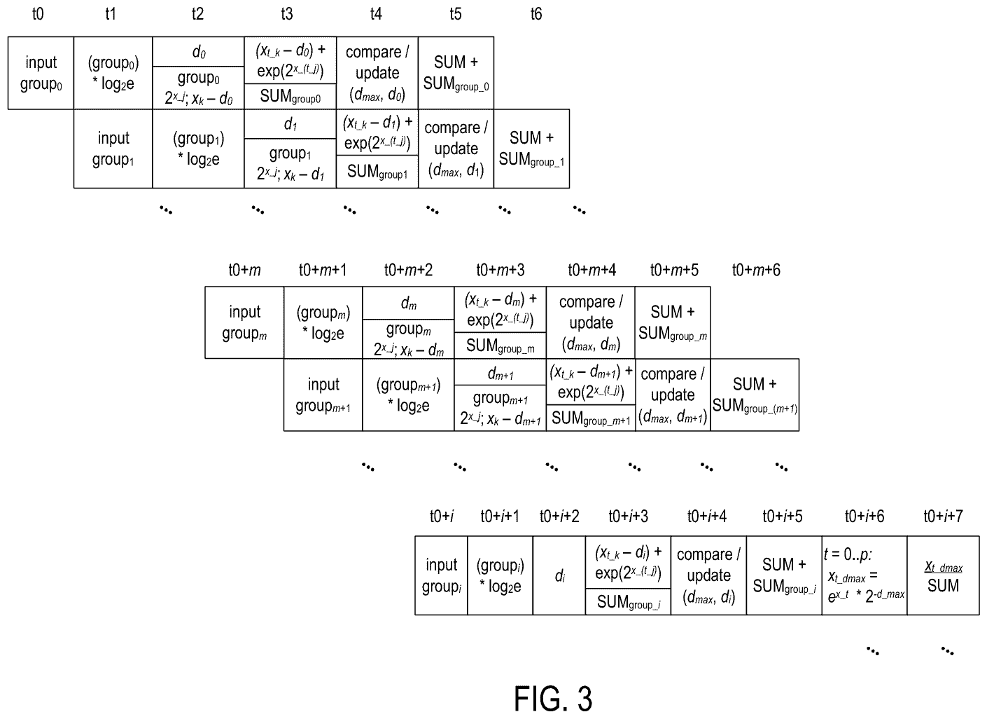

FIG. 3 shows a timing diagram of operations performed in computing the softmax function by the circuit arrangement of FIG. 2. Each block summarizes an operation(s) performed in computing the softmax function, and the horizontal alignment of the blocks indicates relative time slots in which the operations are performed. Vertically aligned blocks indicate operations performed in the same time slot (in parallel).

The example shows the relative timing of operations involved in processing groups 0, 1, m, m+1, and i of i+1 groups of tensor elements (1<m<i). In time slot t0, p+1 tensor elements of a group are input to the circuit arrangement. In time slot t1, the tensor elements of group₀ are multiplied by log₂e, and in parallel therewith, the tensor elements of group₁ are input. In time slot t2, the group-level bias, d₀, is determined, along with polynomial fitting of the xⱼ terms and differences between the xₖ terms and d₀. Also in time slot t2, the tensor elements of group₁ are multiplied by log₂e. Though not shown, the tensor elements of group₃ would be input in time slot t2.

In time slot t3, the differences and exponents of the 2^{(x_t)_j} values computed from group₀ are summed into the group-biased power-of-two elements and stored in association with the group-level bias d₀. The group-biased power-of-two values for group₀ are summed into a group-level sum (“SUM_{group0}”). Also, in time slot t3, the group-level bias, d₁, is determined, along with polynomial fitting of the xⱼ terms and differences between the xₖ terms and d₁.

In time slot t4, the group-level bias, d₀, is compared to the current tensor-level bias, dₘₐₓ, and the current tensor-level dₘₐₓ is updated to the value of d₀, since d₀ is the first maximum computed. Also during time slot t4, the differences and exponents of the 2^{(x_t)_j} values computed from group₁ are summed into the group-biased power-of-two elements and stored in association with the group-level bias d₁. The group-biased power-of-two values for groupo are summed into a group-level sum (“SUM_{group0}”).

In time slot t5, the group-level sum is accumulated with the current SUM. The group-level sum SUM_{group_0} is aligned with the current accumulated SUM according the current dₘₐₓ, and the aligned values are added to produces a new SUM. Also in time slot t5, the group-level bias, d₁, is compared to the current tensor-level bias, dₘₐₓ. If d₁>dₘₐₓ then the current tensor-level bias, dₘₐₓ, is updated to the value of d₁. Otherwise, dₘₐₓ remains unchanged.

In time slot t6, the group-level sum is accumulated with the current SUM. The group-level sum SUM_{group_1} is aligned with the current accumulated SUM according the current dₘₐₓ, and the aligned values are added to produces a new SUM.

FIG. 3 shows similar processing of groupₘ tensor elements beginning in time slot t0+m*(1 time slot), and of groupₘ₊₁ tensor elements beginning in time slot t0+m*(1 time slot)+1.

The final groupᵢ of tensor elements commences in time slot t0+i, and the processing is similar to that described above for time slots t0+i through t0+i t+5. In time slot t0+i+6, the final operations of softmax processing begin.

In time slot t0+i+6, the group-biased power-of-two elements of group₀ and the associated group-level bias d₀ are input, and e^{x_t}*2^{-d_max} values, “x_{t_dmax},” are computed for group₀ as described above. Each e^{x_t}*2^{-d_max} is a floating point value having an exponent equal to x_{t_k}−dₘₐₓ+(the exponent bits of 2^{(x_t)_j}), and a mantissa equal to the mantissa of 2^{(x_t)_j}. In time slot t0+i+7, the p+1 softmax values of group₀ are computed as (x_{t_dmax}/SUM for t=0 . . . p)) and then output. Though not shown, the operations in time slots t0+i+6 and t0+i+7 would be performed for group₁ . . . groupᵢ, in ensuing time slots. For example, in time slot t0+i+7, the group-biased power-of-two elements of group₁ and the associated group-level bias d₁ are input, and e^{x_t}*2^{-d_max} values are computed for group₁. In time slot t0+i+8, the the p+1 softmax values of group₁ are computed as (x_{t_exp}/SUM for t=0 . . . p)) and then output.

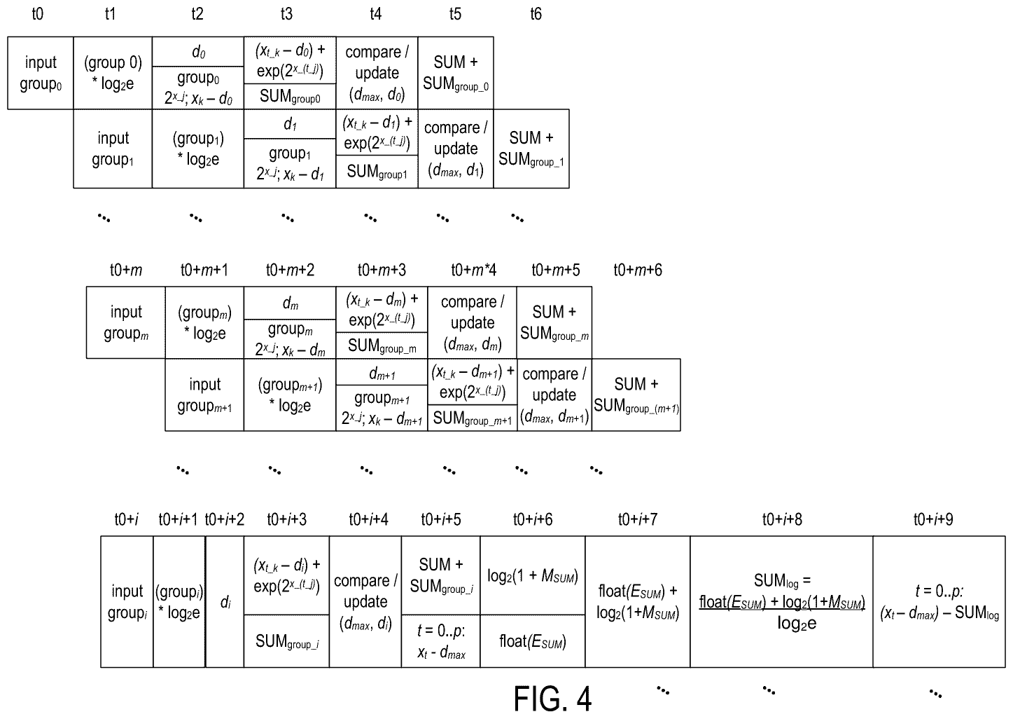

FIG. 4 shows a timing diagram of operations performed by the circuit arrangement of FIG. 2 in computing the log(softmax) function. The operations are the same as those described in FIG. 3 for softmax through time slot t0+i+4.

In time slot t0+i+5, the of p+1 tensor elements of groupo are input and parallel subtraction circuits compute differences between (xₜ−dₘₐₓ for t=0 . . . p).

In timeslot t0+i+6, log₂(1+M_{SUM}) is computed from the mantissa (M_{SUM}) of the SUM, and the exponent of the SUM (E_{SUM}) is converted to a floating point value.

In timeslot t0+i+7, the log₂(1+M_{SUM}) and float(E_{SUM}) values are summed.

In timeslot t0+i+8, the SUM_{log} term is computed from the log₂(1+M_{SUM}) and float(E_{SUM}) values as:

(float(E_{SUM})+log₂(1+M_{SUM}))/log₂e

In timeslot t0+i+9, the p+1 log(softmax) values of group₀ are computed in parallel as (xₜ−dₘₐₓ)−SUM_{log} for t=0 . . . p, and then output.

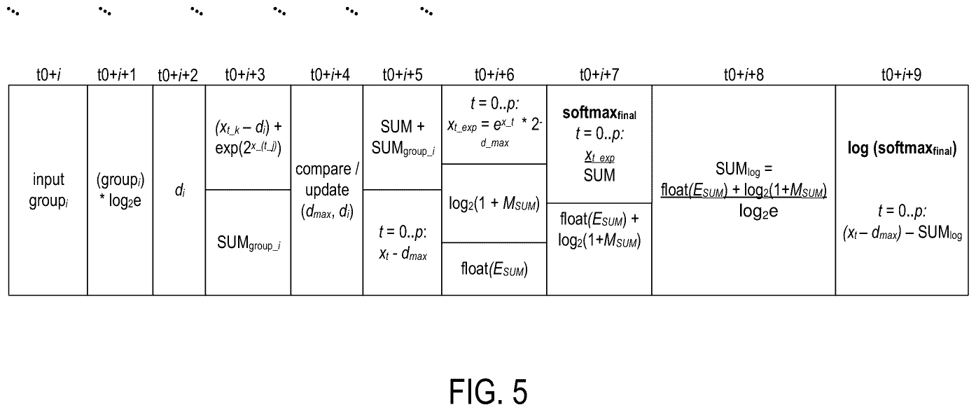

FIG. 5 shows a timing diagram of operations of the softmax function performed in parallel with operations of the log(softmax) function by the circuit arrangement of FIG. 2.

The operations are the same as those described in FIGS. 3 and 4 through time slot t0+i+5. In time slot t0+i+6, the e^{x_t}*2^{-d_max} values are computed in a softmax operation for group₀, and the log₂(1+M_{SUM}) float(E_{SUM}) values are computed in log(softwmax) operations.

In time slot t0+i+7, the p+1 softmax values of group₀ are computed and then output. In parallel with the final softmax operation in time slot t0+i+7, the log₂(1+M_{SUM}) and float(E_{SUM}) values are summed for log(softmax). The log(softmax) operations in time slots t0+i+8 and t0+i+9 are as described in FIG. 4.

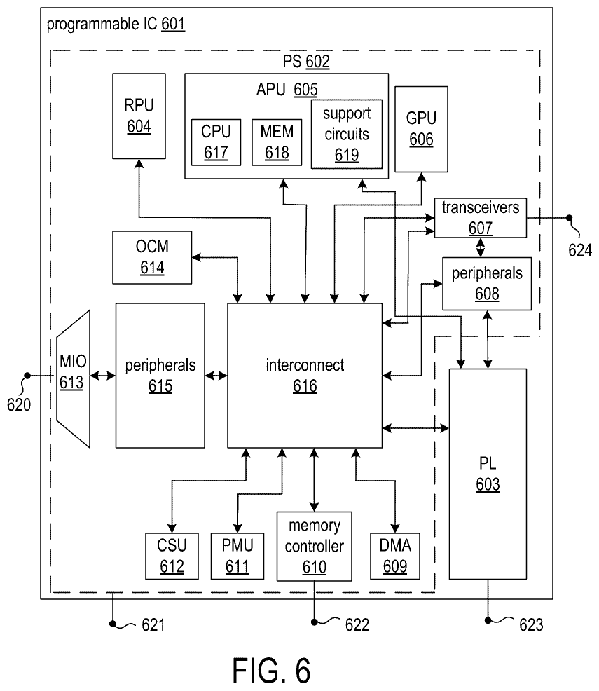

FIG. 6 is a block diagram depicting a System-on-Chip (SoC) 601 that can host circuitry that implements the softmax and log(softmax) functions according to the methods and circuits disclosed herein. In the example, the SoC includes the processing subsystem (PS) 602 and the programmable logic subsystem 603. The processing subsystem 602 includes various processing units, such as a real-time processing unit (RPU) 604, an application processing unit (APU) 605, a graphics processing unit (GPU) 606, a configuration and security unit (CSU) 612, and a platform management unit (PMU) 611. The PS 602 also includes various support circuits, such as on-chip memory (OCM) 614, transceivers 607, peripherals 608, interconnect 616, DMA circuit 609, memory controller 610, peripherals 615, and multiplexed (MIO) circuit 613. The processing units and the support circuits are interconnected by the interconnect 616. The PL subsystem 603 is also coupled to the interconnect 616. The transceivers 607 are coupled to external pins 624. The PL 603 is coupled to external pins 623. The memory controller 610 is coupled to external pins 622. The MIO 613 is coupled to external pins 620. The PS 602 is generally coupled to external pins 621. The APU 605 can include a CPU 617, memory 618, and support circuits 619. The APU 605 can include other circuitry, including L1 and L2 caches and the like. The RPU 604 can include additional circuitry, such as L1 caches and the like. The interconnect 616 can include cache-coherent interconnect or the like.

Referring to the PS 602, each of the processing units includes one or more central processing units (CPUs) and associated circuits, such as memories, interrupt controllers, direct memory access (DMA) controllers, memory management units (MMUs), floating point units (FPUs), and the like. The interconnect 616 includes various switches, busses, communication links, and the like configured to interconnect the processing units, as well as interconnect the other components in the PS 602 to the processing units.

The OCM 614 includes one or more RAM modules, which can be distributed throughout the PS 602. For example, the OCM 614 can include battery backed RAM (BBRAM), tightly coupled memory (TCM), and the like. The memory controller 610 can include a DRAM interface for accessing external DRAM. The peripherals 608, 615 can include one or more components that provide an interface to the PS 602. For example, the peripherals can include a graphics processing unit (GPU), a display interface (e.g., DisplayPort, high-definition multimedia interface (HDMI) port, etc.), universal serial bus (USB) ports, Ethernet ports, universal asynchronous transceiver (UART) ports, serial peripheral interface (SPI) ports, general purpose (GPIO) ports, serial advanced technology attachment (SATA) ports, PCIe ports, and the like. The peripherals 615 can be coupled to the MIO 613. The peripherals 608 can be coupled to the transceivers 607. The transceivers 607 can include serializer/deserializer (SERDES) circuits, MGTs, and the like.

Various logic may be implemented as circuitry to carry out one or more of the operations and activities described herein and/or shown in the figures. In these contexts, a circuit or circuitry may be referred to as “logic,” “module,” “engine,” or “block.” It should be understood that logic, modules, engines and blocks are all circuits that carry out one or more of the operations/activities. In certain implementations, a programmable circuit is one or more computer circuits programmed to execute a set (or sets) of instructions stored in a ROM or RAM and/or operate according to configuration data stored in a configuration memory.

Though aspects and features may in some cases be described in individual figures, it will be appreciated that features from one figure can be combined with features of another figure even though the combination is not explicitly shown or explicitly described as a combination.

The methods and circuits are thought to be applicable to a variety of systems that compute softmax and log(softmax) functions. Other aspects and features will be apparent to those skilled in the art from consideration of the specification. The methods and circuits may be implemented as one or more processors configured to execute software, as an application specific integrated circuit (ASIC), or as a logic on a programmable logic device. It is intended that the specification and drawings be considered as examples only, with a true scope of the invention being indicated by the following claims.

What is claimed is:

1. A method comprising:
transforming in parallel, elements of each group of a plurality of groups of elements of a tensor X into respective power-of-two elements by a processor circuit, wherein the respective power-of-two element from element xₜ of the tensor is pₜ, pₜ=(xₜ*log₂e), and pₜ has an integer part and a fraction part;
determining respective group-level biases for the groups by a comparison circuit (204), wherein the group-level bias of groupₘ is dₘ, and dₘ is an integer part of a maximum of the power-of-two elements of groupₘ; and
determining a greatest one of the respective group-level biases by the comparison circuit to be a tensor-level bias, dₘₐₓ.

2. The method of claim 1, further comprising:
adjusting in parallel by a plurality of adder circuits, the respective power-of-two elements of each group into respective group-biased elements based on the respective group-level biases to prevent underflow and overflow;
summing the respective group-biased elements by an accumulator circuit for each group into a group-level sum; and
summing the group-level sums into a tensor-level sum by an update circuit.

3. The method of claim 2, further comprising:
adjusting the respective group-biased elements into respective tensor-biased elements corresponding to the elements of the tensor based on dₘₐₓ, the respective group-level biases, and exponents of the group-biased elements; and
determining softmax values in parallel for elements of each group by a processor circuit, wherein the softmax value of xₜ=(tensor-biased element corresponding to xₜ)/(tensor-level sum).

4. The method of claim 3, further comprising:
determining a log-tensor-sum=logₑ(tensor-level sum) by a processor circuit; and
determining log-softmax values in parallel for the elements xₜ of each group by a processor circuit, wherein log(softmax(xₜ))=xₜ−dₘₐₓ−(log-tensor-sum).

5. The method of claim 4, wherein determining softmax values is performed by a first processor circuit, and determining log-softmax values is performed by a second processor circuit, and the first processor circuit and the second processor circuit operate in parallel.

6. The method of claim 4, wherein determining softmax values is performed by a first processor circuit, and determining log-softmax values is performed by a second processor circuit, and the method further comprising:
activating the first processor circuit and deactivating the second processor circuit in response to a first state of mode control signals; and
deactivating the first processor circuit and activating the second processor circuit in response to a second state of the mode control signals.

7. The method of claim 3, wherein the group-biased element of xₜ of group m is equal to e^{x_t}*2^{-d_m}, and the adjusting the respective power-of-two elements into respective group-biased elements includes:
determining in parallel by a plurality of subtractor circuits, differences between integer portions, x_{t_k}, of the respective power-of-two elements of a group m and the respective group-level bias, dₘ;
determining in parallel by a processor circuit from fraction portions, x_{t_j}, of the respective power-of-two elements of the group m, floating point values of 2^{(x_t)_j}; and
determining in parallel by a plurality of adder circuits, exponents of the respective group-biased elements in parallel as sums of the differences from the plurality of subtractor circuits and exponents of the floating point values 2^{(x_t)_j}.

8. The method of claim 3, wherein transforming the elements of each group into respective power-of-two elements includes transforming the elements of group m+1 of the plurality of groups concurrent with the comparison circuit determining the respective group-level bias for group m.

9. The method of claim 3, wherein:
determining the respective group-level biases includes determining the respective group-level biases of the groups in successive time intervals such that the group-level bias of group m is determined in a first time interval, and the group-level bias of group m+1 is determined in a second time interval that follows the first time interval in succession;
determining the tensor-level bias includes determining and registering a current tensor-level bias by a comparison circuit that compares the current tensor-level bias to the respective group-level bias as each group-level bias is determined; and
wherein summing the group-level sums into the tensor-level sum includes aligning each group-level sum with a current tensor-level sum based on the current tensor-level bias, adding the group-level sum to the current tensor level sum after aligning the group-level sum, and registering an update of the current tensor-level sum.

10. The method of claim 3, wherein adjusting the respective group-biased elements into respective tensor-biased elements includes:
determining a difference between each group-level bias dₘ and the tensor-level bias, dₘₐₓ, by a subtractor circuit as (dₘ−dₘₐₓ); and
determining exponents of the respective group-biased elements in parallel by a plurality of adder circuits, wherein each exponent is a sum of (dₘ−dₘₐₓ)+(the exponent of the respective group-biased element).

11. A circuit arrangement, comprising:
a first processor circuit configured to transform in parallel, elements of each group of a plurality of groups of elements of a tensor X into respective power-of-two elements, wherein the respective power-of-two element from element xₜ of the tensor is pₜ, pₜ=(xₜ*log₂e), and pₜ has an integer part and a fraction part;
a first comparison circuit (204) configured to determine respective group-level biases for the groups, wherein the group-level bias of groupₘ is dₘ, and dₘ is an integer part of a maximum of the power-of-two elements of groupₘ; and
a second comparison circuit configured to determine a greatest one of the respective group-level biases to be a tensor-level bias, dₘₐₓ.

12. The circuit arrangement of claim 11, further comprising:
a pluralty of adder circuits configured to adjust the respective power-of-two elements of each group in parallel into respective group-biased elements based on the respective group-level biases to prevent underflow and overflow;
an accumulator circuit configured to sum the respective group-biased elements for each group into a group-level sum;
an update circuit configured to sum the group-level sums into a tensor-level sum.

13. The circuit arrangement of claim 12, further comprising:
an adjustment circuit configured to adjust the respective group-biased elements into respective tensor-biased elements corresponding to the elements of the tensor based on dₘₐₓ, the respective group-level biases, and exponents of the group-biased elements; and
a second processor circuit configured to determine softmax values in parallel for elements of each group, wherein the softmax value of xₜ=(tensor-biased element corresponding to xₜ)/(tensor-level sum).

14. The circuit arrangement of claim 13, further comprising:
a third processor circuit configured to determine a log-tensor-sum=logₑ(tensor-level sum); and
a fourth processor circuit configured to determine log-softmax values in parallel for the elements xₜ of each group, wherein log(softmax (xₜ))=xₜ−dₘₐₓ−(log-tensor-sum).

15. The circuit arrangement of claim 14, wherein the first, second, third, and fourth processor circuits are configured to operate in parallel.

16. The circuit arrangement of claim 14, further comprising a control circuit configured to
activate the first and second processor circuits and deactivating the third and fourth processor circuits in response to a first state of mode control signals; and
deactivate the first and second processor circuits and activating the third and fourth processor circuits in response to a second state of the mode control signals.

17. The circuit arrangement of claim 13, wherein the group-biased element of xₜ of group m is equal to e^{x_t}*2^{-d_m}, and further comprising:
a plurality of subtractor circuits configured to determine in parallel, differences between integer portions, x_{t_k}, of the respective power-of-two elements of a group m and the respective group-level bias, dₘ;
a third processor circuit configured to determine floating point values of 2^{(x_t)_j} in parallel from fraction portions, x_{t_j}, of the respective power-of-two elements of the group m; and
a plurality of adder circuits configured to determine in parallel, exponents of the respective group-biased elements in parallel as sums of the differences from the plurality of subtractor circuits and exponents of the floating point values 2^{(x_t)_j}.

18. The circuit arrangement of claim 13, wherein the first processor circuit is configured to transform the elements of group m+1 of the plurality of groups concurrent with the comparison circuit determining the respective group-level bias for group m.

19. The circuit arrangement of claim 13, wherein:
the first comparison circuit is configured to determine the respective group-level biases of the groups in successive time intervals such that the group-level bias of group m is determined in a first time interval, and the group-level bias of group m+1 is determined in a second time interval that follows the first time interval in succession;
the second comparison circuit is configured to determine and register a current tensor-level bias by a comparison circuit that compares the current tensor-level bias to the respective group-level bias as each group-level bias is determined; and
the update circuit is configured to align each group-level sum with a current tensor-level sum based on the current tensor-level bias, add the group-level sum to the current tensor level sum after aligning the group-level sum, and register an update of the current tensor-level sum.

20. The circuit arrangement of claim 13, wherein the adjustment circuit includes:
a subtractor circuit configured to determine a difference between each group-level bias dₘ and the tensor-level bias, dₘₐₓ, by as (dₘ−dₘₐₓ); and
a plurality of adder circuits configured to determine exponents of the respective group-biased elements in parallel, wherein each exponent is a sum of (dₘ−dₘₐₓ)+(the exponent of the respective group-biased element).
